(19) United States
(12) Patent Application Publication
(10) Pub. No.: US 2022/0091304 A1
(43) Pub. Date: Mar. 24, 2022

(54) MICROLENS ARRAY AND METHOD FOR MANUFACTURING THE SAME

(71) Applicant: Japan Display Inc., Tokyo (JP)

(72) Inventor: Junko NAGASAWA, Tokyo (JP)

(73) Assignee: Japan Display Inc., Tokyo (JP)

(21) Appl. No.: 17/447,961

(22) Filed: Sep. 17, 2021

(30) Foreign Application Priority Data
Sep. 18, 2020 (JP) 2020-157587

(51) Int. Cl. G02B 3/00; G02B 1/04

(52) U.S. Cl. CPC G02B 3/0012; G02B 1/04; G02B 3/0037

(57) ABSTRACT

According to one embodiment, a method for manufacturing a microlens array includes forming a first resin layer, exposing the first resin layer through a photomask, developing the first resin layer to form a vacant space of the first resin layer, melting the first resin layer to form a first microlens, forming a second resin layer over the first microlens and the vacant space, exposing the second resin layer in a state where a light shielding portion faces the vacant space and a light transmissive portion faces the first microlens, developing the second resin layer, and melting the second resin layer to form a second microlens in contact with the first microlens.

### CROSS-REFERENCE TO RELATED APPLICATION

This application is based upon and claims the benefit of priority from Japanese Patent Application No. 2020-157587, filed Sep. 18, 2020, the entire contents of which are incorporated herein by reference.

### FIELD

Embodiments described herein relate generally to a microlens array and a method for manufacturing the same.

### BACKGROUND

As a method for manufacturing a microlens array, there is known a manufacturing method in which, for example, a photosensitive resin layer having thermal reflow properties is exposed through a photomask having a predetermined pattern and is subjected to patterning treatment such as development to form a resist pattern, and the resist pattern is thermally melted to form a microlens array (or a lens matrix).

It is desired to realize a lens array in which an interval between adjacent microlenses is substantially zero.

### BRIEF DESCRIPTION OF THE DRAWINGS

FIG. 1 is a plan view illustrating a first configuration example of a microlens array 1 according to the present embodiment.

FIG. 2 is a cross-sectional view of the microlens array 1 taken along line A-B in FIG. 1.

FIG. 3 is a flowchart for explaining a first method for manufacturing the microlens array 1.

FIG. 4 is a view for explaining a first lens forming process ST1 illustrated in FIG. 3.

FIG. 5 is a view for explaining a second lens forming process ST2 illustrated in FIG. 3.

FIG. 6 is a plan view illustrating a second configuration example of a microlens array 1 according to the present embodiment.

FIG. 7 is a view for explaining a first lens forming process ST1 for the second configuration example.

FIG. 8 is a view for explaining a second lens forming process ST2 for the second configuration example.

FIG. 9 is a plan view illustrating a third configuration example of a microlens array 1 according to the present embodiment.

FIG. 10 is a cross-sectional view of the microlens array 1 taken along line C-D in FIG. 9.

FIG. 11 is a flowchart for explaining a second method for manufacturing the microlens array 1.

FIG. 12 is a view for explaining a first lens forming process ST1 for the third configuration example.

FIG. 13 is a plan view illustrating microlenses L11 to L18 formed in the first lens forming process ST1 illustrated in FIG. 12.

FIG. 14 is a view for explaining a second lens forming process ST2 for the third configuration example.

FIG. 15 is a plan view illustrating microlenses L21 to L27 formed in the second lens forming process ST2 illustrated in FIG. 14.

FIG. 16 is a view for explaining a third lens forming process ST3 for the third configuration example.

FIG. 17 is a plan view illustrating microlenses L31 to L37 formed in the third lens forming process ST3 illustrated in FIG. 16.

FIG. 18A is a diagram illustrating light beams passing through a microlens L and a base layer 10.

FIG. 18B is a diagram illustrating light beams passing through the microlens L and the base layer 10.

FIG. 18C is a diagram illustrating light beams passing through the microlens L and the base layer 10.

FIG. 19 is an exploded perspective view illustrating a configuration example of an electronic device 100.

FIG. 20 is a cross-sectional view of the electronic device 100 including a photodetector PD in FIG. 19.

### DETAILED DESCRIPTION

In general, according to one embodiment, there is provided a method for manufacturing a microlens array including forming a first resin layer that is photosensitive on a base layer, exposing the first resin layer through a photomask including a light shielding portion and a light transmissive portion, developing the first resin layer to form a vacant space of the first resin layer, melting the first resin layer that is remaining to form a first microlens, forming a second resin layer that is photosensitive over the first microlens and the vacant space, exposing the second resin layer in a state where a light shielding portion of a photomask faces the vacant space and a light transmissive portion of the photomask faces the first microlens, developing the second resin layer to remove the second resin layer on the first microlens, and melting the second resin layer that is remaining to form a second microlens in contact with the first microlens.

Furthermore, according to the present embodiment, there is provided a method for manufacturing a microlens array including forming a first resin layer that is photosensitive over a first area and a second area adjacent to each other on a base layer, exposing the first resin layer in a state where a light shielding portion of a photomask faces the first area and a light transmissive portion of the photomask faces the second area, developing the first resin layer to remove the first resin layer in the second area, melting the first resin layer that is remaining in the first area to form a first microlens, forming a second resin layer that is photosensitive over the first microlens and the second area, exposing the second resin layer in a state where a light shielding portion of a photomask faces the second area and a light transmissive portion of the photomask faces the first microlens, developing the second resin layer to remove the second resin layer on the first microlens, and melting the second resin layer that is remaining in the second area to form a second microlens in contact with the first microlens.

Furthermore, according to the present embodiment, there is provided a microlens array including a base layer, and a first microlens and a second microlens that are disposed on the base layer and are in contact with each other, in which an entire perimeter of an edge of the first microlens is in contact with the base layer, and a portion of an edge of the second microlens is in contact with a surface of the first microlens.

Hereinafter, the present embodiment will be described with reference to the drawings. Note that the disclosure is merely an example, and appropriate modifications that can be easily conceived by those skilled in the art while maintaining the gist of the invention are naturally included in the scope of the present invention. In the drawings, in order to make the description clearer, a width, a thickness, a shape, and the like of each part may be represented schematically as compared with an actual mode, but they are merely examples and do not limit interpretation of the present invention. In addition, in the present specification and the drawings, a component that exhibits a function the same as or similar to that previously described with respect to a preceding figure is denoted by the same reference sign, and redundant detailed description may be appropriately omitted.

Note that an X-axis, a Y-axis, and a Z-axis perpendicular to each other are shown in the drawings as necessary for easy understanding. A direction along the X-axis is referred to as a first direction X, a direction along the Y-axis is referred to as a second direction Y, and a direction along the Z-axis is referred to as a third direction Z. A plane defined by the X-axis and the Y-axis is referred to as an X-Y plane, and a view on the X-Y plane is referred to as a plan view.

### First Configuration Example

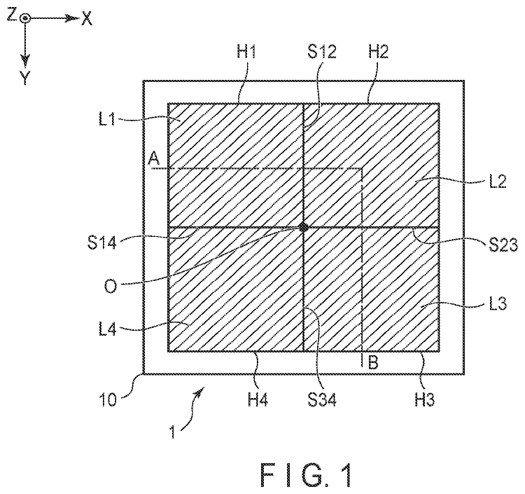

FIG. 1 is a plan view illustrating a first configuration example of a microlens array 1 according to the present embodiment. The microlens array 1 includes a base layer 10 and a plurality of microlenses L1 to L4. In the example illustrated in FIG. 1, each of the microlenses L1 to L4 has a quadrangular shape in plan view. A quadrangle herein includes a square, a rectangle, a parallelogram, a trapezoid, and the like. That is, the microlenses L1 to L4 have quadrangular edges H1 to H4 in plan view, respectively.

The microlenses L1 and L2 are arranged in the first direction X, are in contact with each other, and share a side S12 extending in the second direction Y. The microlenses L1 and L4 are arranged in the second direction Y, are in contact with each other, and share a side S14 extending in the first direction X. The microlenses L2 and L3 are arranged in the second direction Y, are in contact with each other, and share a side S23 extending in the first direction X. The microlenses L4 and L3 are arranged in the first direction X, are in contact with each other, and share a side S34 extending in the second direction Y. The side S12 and the side S34 are located on a single straight line, and the side S14 and the side S23 are located on a single straight line. These sides S12, S34, S14, and S23 intersect at a center O.

The microlenses L1 and L3 are diagonally arranged and are in contact with each other at the center O. The microlenses L2 and L4 are diagonally arranged and are in contact with each other at the center O. That is, these four microlenses L1 to L4 are in contact with each other without a gap.

For example, the microlenses L1 and L3 are formed prior to the microlenses L2 and L4. As a result, a whole of the edge H1 of the microlens L1 and a whole of the edge H3 of the microlens L3 are in contact with the base layer 10. Meanwhile, a whole of the edge H2 of the microlens L2 and a whole of the edge H4 of the microlens L4 may be in contact with the base layer 10.

Alternatively, a portion of the edge H2 and a portion of the edge H4 each may overlap the microlenses L1 and L3. For example, as for the microlens L2, a portion of the edge H2 along the side S12 may overlap the microlens L1, and a portion of the edge H2 along the side S23 may overlap the microlens L3. Similarly, as for the microlens L4, a portion of the edge H4 along the side S14 may overlap the microlens L1, and a portion of the edge H4 along the side S34 may overlap the microlens L3.

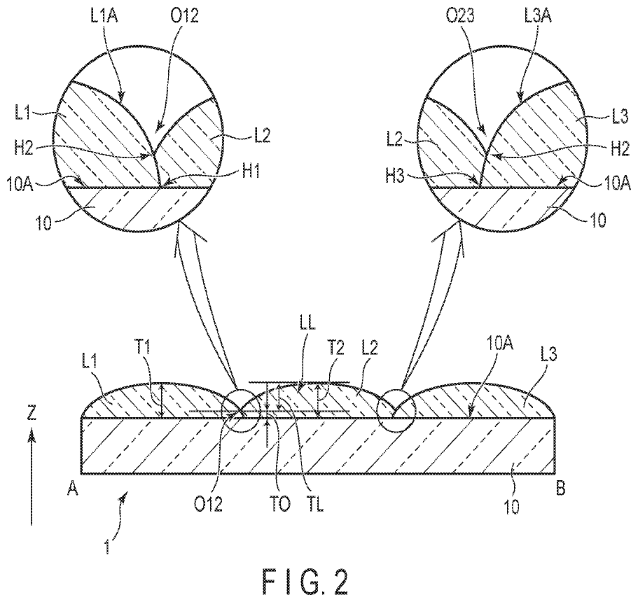

FIG. 2 is a cross-sectional view of the microlens array 1 taken along line A-B in FIG. 1. The example illustrated in FIG. 2 corresponds to a case where the edge H2 of the microlens L2 overlaps the microlenses L1 and L3. That is, the microlens L2 of the example illustrated in FIG. 2 includes an overlapping portion O12 overlapping the microlens L1 and an overlapping portion O23 overlapping the microlens L3. There are illustrated an enlarged view of the overlapping portion O12 on the left side in FIG. 2 and an enlarged view of the overlapping portion O23 on the right side in FIG. 2.

The microlenses L1 to L3 are disposed on the base layer 10. The edge H1 of the microlens L1 and the edge H3 of the microlens L3 are in contact with an upper surface 10A of the base layer 10.

The edge H2 of the microlens L2 is separated from the upper surface 10A, and is in contact with a surface L1A of the microlens L1 on the left side in the figure, and is in contact with a surface L3A of the microlens L3 on the right side in the figure. Note that the surface L1A between the edge H1 and the edge H2 can be recognized as a boundary between the microlens L1 and the microlens L2, and the surface L3A between the edge H2 and the edge H3 can be recognized as a boundary between the microlens L2 and the microlens L3.

The microlenses L1 and L2 have thicknesses T1 and T2, respectively. In an example, the thickness T1 is equivalent to the thickness T2. The thicknesses T1 and T2 each correspond to a length along the third direction Z from the upper surface 10A to a top of the microlens.

As in the example illustrated in FIG. 2, when the microlens L2 overlaps respective portions of the microlenses L1 and L3, a portion prominent from the overlapping portions functions as a lens portion. For example, the microlens L2 includes a lens portion LL prominent in the third direction Z from the overlapping portion O12. The overlapping portion O12 has a thickness TO corresponding to a length from the upper surface 10A to the edge H2 along the third direction Z. The lens portion LL has a thickness TL corresponding to a length from the edge H2 to the top of the microlens L2 along the third direction Z.

The thickness T2 corresponds to a sum of the thickness TO of the overlapping portion O12 and the thickness TL of the lens portion LL (T2=TO+TL). The lens portion LL is thicker than the overlapping portion O12. That is, the thickness TL is greater than the thickness TO (TO<TL). Note that it is possible to make the thickness TO of the overlapping portion O12 substantially zero. That is, when the microlens L2 does not overlap the microlens L1 and the edges H1 and H2 are in contact with each other, the thickness TO is zero.

Next, a first method for manufacturing the microlens array 1 according to the present embodiment will be described.

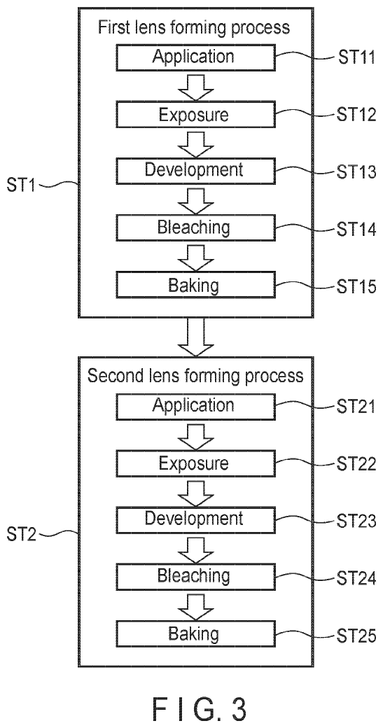

FIG. 3 is a flowchart for explaining the first method for manufacturing the microlens array 1.

First, a first lens forming process of forming the microlenses L1 and L3 illustrated in FIG. 1 is performed (step ST1). Subsequently, a second lens forming process of forming the microlenses L2 and L4 illustrated in FIG. 1 is performed (step ST2).

The first lens forming process and the second lens forming process each include an application process (steps ST11 and ST21), an exposure process (steps ST12 and ST22), a development process (steps ST13 and ST23), a bleaching process (steps ST14 and ST24), and a baking process (steps ST15 and ST25).

In the application process (steps ST11 and ST21), a photopolymer material (for example, an ultraviolet curable resin material) is applied onto the base layer 10 to form a resin layer. The photopolymer material applicable herein is a positive resin material that becomes soluble in a developer due to a chemical change when irradiated with light.

In the exposure process (steps ST12 and ST22), the resin layer is exposed through a photomask including a light shielding portion and a light transmissive portion. The photomask has a pattern of the microlenses to be formed as the light shielding portion. Ultraviolet rays are applicable to the exposure, for example.

In the development process (steps ST13 and ST23), the resin layer is developed in the developer. As a result, a portion of the resin layer exposed through the light transmissive portion of the photomask is removed, and a portion of the resin layer not exposed because of the light shielding portion of the photomask remains.

In the bleaching process (steps ST14 and ST24), an entire area of the resin layer remaining on the base layer 10 is irradiated with ultraviolet rays.

In the baking process (steps ST15 and ST25), the remaining resin layer is heated at a predetermined temperature and is thus melted. At that time, surface tension generated in the molten resin layer causes the resin layer to be formed into a substantially hemispherical shape. Thereafter, the resin layer is cured again, resulting in formation of a convex microlens.

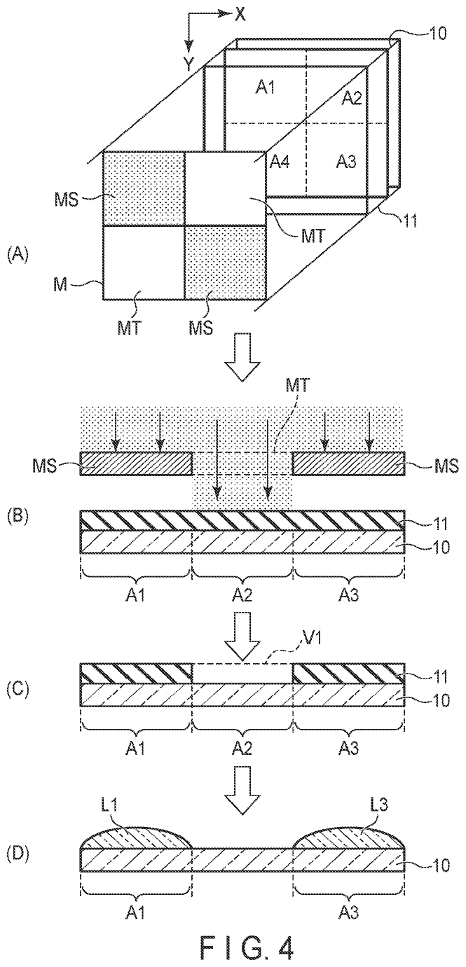

FIG. 4 is a view for explaining the first lens forming process ST1 illustrated in FIG. 3. (A) of FIG. 4 is a perspective view illustrating areas A1 to A4 on the base layer 10, and (B), (C), and (D) of FIG. 4 are cross-sectional views illustrating the areas A1 to A3 on the base layer 10.

First, as illustrated in (A) of FIG. 4, a photosensitive first resin layer 11 is formed over the areas A1 to A4 on the base layer 10 (ST11). The area A1 and the area A2 are adjacent to each other in the first direction X, the area A2 and the area A3 are adjacent to each other in the second direction Y, the area A4 and the area A3 are adjacent to each other in the first direction X, and the area A1 and the area A4 are adjacent to each other in the second direction Y.

Thereafter, a photomask M is aligned to form a state in which light shielding portions MS of the photomask M individually face the areas A1 and A3 and light transmissive portions MT of the photomask M individually face the areas A2 and A4. The light shielding portions MS of the photomask M applicable herein have quadrangular shapes individually corresponding to the areas A1 and A3, and the light transmissive portions MT of the photomask M have quadrangular shapes individually corresponding to the areas A2 and A4. There is little gap between the diagonally arranged light shielding portions MS.

Subsequently, as illustrated in (B) of FIG. 4, the first resin layer 11 is exposed through the photomask M in the state where the light shielding portions MS face the areas A1 and A3 and the light transmissive portion MT faces the area A2 (ST12). As a result, a portion of the first resin layer 11 formed in the area A2 becomes soluble in the developer due to the chemical change.

Subsequently, as illustrated in (C) of FIG. 4, the first resin layer 11 is developed, resulting in removal of the first resin layer in the area A2 (ST13). That is, a vacant space (or a removed portion) V1 of the first resin layer 11 is formed in the area A2. The first resin layer 11 remains in the areas A1 and A3. Thereafter, although not illustrated, the remaining first resin layer 11 is subjected to bleaching treatment (ST14).

Subsequently, as illustrated in (D) of FIG. 4, the remaining first resin layer 11 is baked (ST15). As a result, the first resin layer 11 in the areas A1 and A3 is melted, resulting in formation of the microlens L1 in the area A1 and the microlens L3 in the area A3.

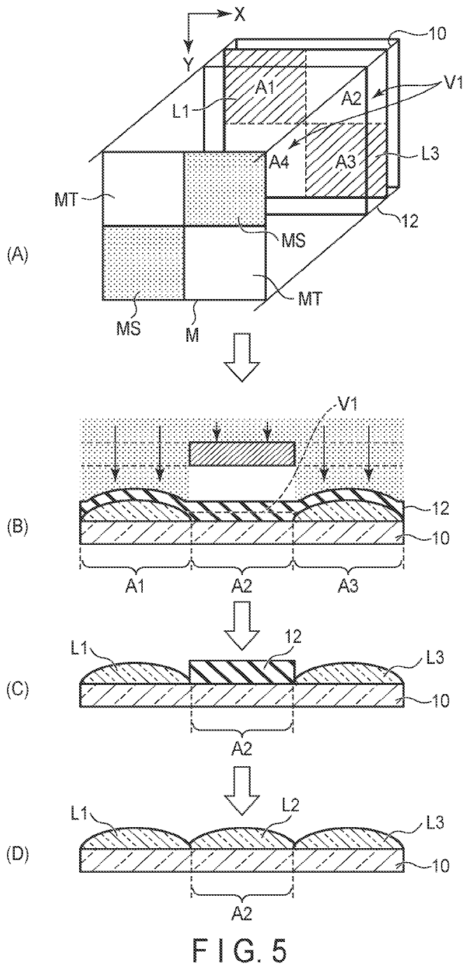

FIG. 5 is a view for explaining the second lens forming process ST2 illustrated in FIG. 3. (A) of FIG. 5 is a perspective view illustrating the areas A1 to A4 on the base layer 10, and (B), (C), and (D) of FIG. 5 are cross-sectional views illustrating the areas A1 to A3 on the base layer 10.

First, as illustrated in (A) of FIG. 5, a photosensitive second resin layer 12 is formed over the areas A1 to A4 on the base layer 10 (ST21). At this time, the second resin layer 12 is disposed over the microlens L1 in the area A1, is disposed in the vacant space V1 in the area A2, and is disposed over the microlens L3 in the area A3.

Thereafter, the photomask M is aligned to form a state in which the light shielding portions MS of the photomask M individually face the areas A2 and A4 and the light transmissive portions MT of the photomask M individually face the areas A1 and A3.

Note that the light shielding portions MS and the light transmissive portions MT of the photomask M applied in the second lens forming process are the same in shape as those of the photomask M applied in the first lens forming process. Therefore, the common photomask M can be used in the first lens forming process and the second lens forming process.

Subsequently, as illustrated in (B) of FIG. 5, the second resin layer 12 is exposed through the photomask M in the state where the light shielding portion MS faces the area A2 or the vacant space V1 and the light transmissive portions MT face the microlens L1 in the area A1 and the microlens L3 in the area A3 (ST22). As a result, portions of the second resin layer 12 formed in the areas A1 and A3 become soluble in the developer due to the chemical change.

Subsequently, as illustrated in (C) of FIG. 5, the second resin layer 12 is developed, resulting in removal of the second resin layer on the microlens L1 in the area A1 and the second resin layer on the microlens L3 in the area A3 (ST23). The second resin layer 12 remains in the area A2. Thereafter, although not illustrated, the remaining second resin layer 12 is subjected to the bleaching treatment (ST24).

Subsequently, as illustrated in (D) of FIG. 5, the remaining second resin layer 12 is baked (ST25). As a result, the second resin layer 12 in the area A2 is melted, resulting in formation of the microlens L2 in the area A2. The area A2 is adjacent to the area A1 and the area A3, and the microlens L2 is in contact with the microlens L1 and the microlens L3. Although not illustrated, baking the second resin layer 12 results in formation of the microlens L4 in the area A4.

As described above, the adjacent microlenses are formed in the separate lens forming processes using the photopolymer material. This allows for formation of a microlens array in which microlenses are arranged without a gap. Therefore, density of the microlenses can be increased. Furthermore, light passing through a gap between the adjacent microlenses is reduced, and thus light use efficiency can be improved.

In addition, the resin layer around the microlens is removed up to the upper surface of the base layer in the process of separately forming each of the microlenses. This allows for making thickness between the adjacent microlenses (the thickness of the overlapping portion) substantially zero, and thus thickness of the microlens array can be reduced.

### Second Configuration Example

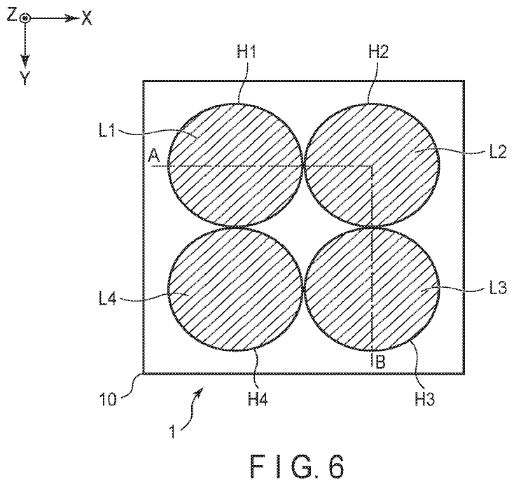

FIG. 6 is a plan view illustrating a second configuration example of a microlens array 1 according to the present embodiment. The second configuration example illustrated in FIG. 6 is different from the first configuration example illustrated in FIG. 1 in that each of microlenses L1 to L4 has a circular shape in plan view. That is, the microlenses L1 to L4 have circular edges H1 to H4 in plan view, respectively.

The microlenses L1 and L2 are arranged in the first direction X and are in contact with each other. The microlenses L1 and L4 are arranged in the second direction Y and are in contact with each other. The microlenses L2 and L3 are arranged in the second direction Y and are in contact with each other. The microlenses L4 and L3 are arranged in the first direction X and are in contact with each other. The microlenses L1 and L3 are diagonally arranged and are separated from each other. The microlenses L2 and L4 are diagonally arranged and are separated from each other.

For example, when the microlenses L1 and L3 are formed prior to the microlenses L2 and L4, a whole of the edge H1 of the microlens L1 and a whole of the edge H3 of the microlens L3 are in contact with a base layer 10. Meanwhile, a whole of the edge H2 of the microlens L2 and a whole of the edge H4 of the microlens L4 may be in contact with the base layer 10.

Alternatively, a portion of the edge H2 and a portion of the edge H4 each may overlap the microlenses L1 and L3. In this case, a cross section taken along line A-B passing through a position where the microlens L1 and the microlens L2 are in contact with each other and a position where the microlens L2 and the microlens L3 are in contact with each other is as illustrated in FIG. 2.

Also in the second configuration example, the first manufacturing method described with reference to FIG. 3 is applicable.

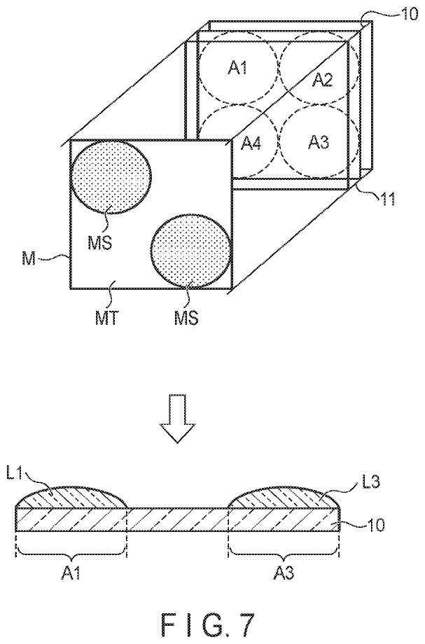

FIG. 7 is a view for explaining a first lens forming process ST1 for the second configuration example.

First, a photosensitive first resin layer 11 is formed over areas A1 to A4 on the base layer 10 (ST11). Thereafter, a photomask M is aligned to form a state in which light shielding portions MS of the photomask M individually face the areas A1 and A3 and a light transmissive portion MT of the photomask M faces another area including the areas A2 and A4. The light shielding portions MS of the photomask M applicable herein have a circular shape. The light shielding portions MS are arranged at intervals.

Subsequently, as illustrated in (B) of FIG. 4, the first resin layer 11 is exposed through the photomask M (ST12). Subsequently, as illustrated in (C) of FIG. 4, the first resin layer 11 is developed (ST13), and is then subjected to bleaching treatment (ST14). Subsequently, as illustrated in (D) of FIG. 4, the remaining first resin layer 11 is baked (ST15). This results in formation of the microlens L1 in the area A1 and the microlens L3 in the area A3.

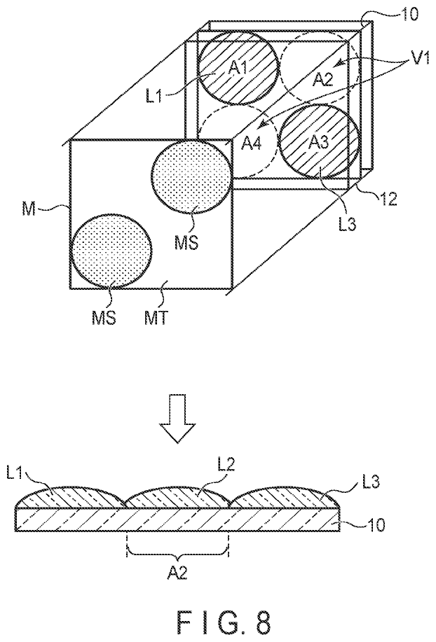

FIG. 8 is a view for explaining a second lens forming process ST2 for the second configuration example.

First, a photosensitive second resin layer 12 is formed over the areas A1 to A4 on the base layer 10 (ST21). At this time, the second resin layer 12 is disposed over the microlens L1 in the area A1, and is disposed over the microlens L3 in the area A3.

Thereafter, the photomask M is aligned to form a state in which the light shielding portions MS of the photomask M individually face the areas A2 and A4 and the light transmissive portion MT of the photomask M faces another area including the areas A1 and A3.

Subsequently, as illustrated in (B) of FIG. 5, the second resin layer 12 is exposed through the photomask M (ST22). Subsequently, as illustrated in (C) of FIG. 5, the second resin layer 12 is developed (ST23), and is then subjected to the bleaching treatment (ST24). Subsequently, as illustrated in (D) of FIG. 5, the remaining second resin layer 12 is baked (ST25). This results in formation of the microlens L2 in the area A2. At the same time, the microlens L4 is formed in the area A4.

Note that the light shielding portions MS and the light transmissive portions MT of the photomask M applied in the second lens forming process are the same in shape as those of the photomask M applied in the first lens forming process. Therefore, the common photomask M can be used in the first lens forming process and the second lens forming process.

In such a second configuration example, similar effects to those in the first configuration example can be achieved.

In the first configuration example and the second configuration example, for example, the microlens L1 corresponds to a first microlens, the microlens L2 corresponds to a second microlens, the area A1 corresponds to a first area, and the area A2 corresponds to a second area.

### Third Configuration Example

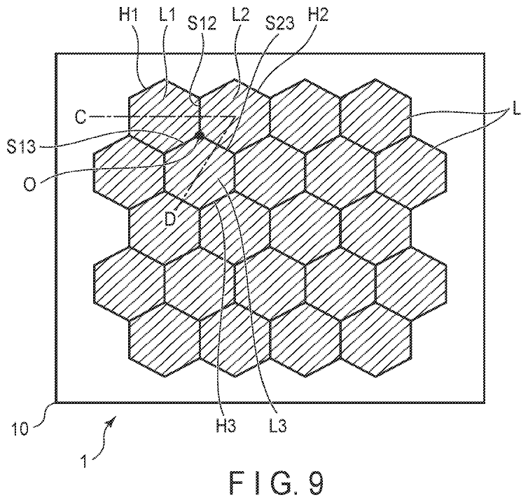

FIG. 9 is a plan view illustrating a third configuration example of a microlens array 1 according to the present embodiment. The third configuration example illustrated in FIG. 9 is different from the first configuration example illustrated in FIG. 1 in that microlenses L are disposed to form a close-packed structure. Each of the microlenses L has a hexagonal shape in plan view.

For example, microlenses L1 to L3 among the microlenses L have hexagonal edges H1 to H3 in plan view, respectively.

The microlenses L1 and L2 are arranged in the first direction X, are in contact with each other, and share a side S12 extending in the second direction Y. The microlenses L2 and L3 are obliquely arranged, are in contact with each other, and share a side S23. The microlenses L1 and L3 are obliquely arranged, are in contact with each other, and share a side S13. These sides S12, S23, and S13 intersect at a center O. That is, these three microlenses L1 to L3 are in contact with each other without a gap.

For example, the microlens L1 is formed prior to the microlenses L2 and L3, and the microlens L2 is formed prior to the microlens L3. As a result, a whole of the edge H1 of the microlens L1 is in contact with a base layer 10. Meanwhile, a whole of the edge H2 of the microlens L2 and a whole of the edge H3 of the microlens L3 may be in contact with the base layer 10.

Alternatively, a portion of the edge H2 of the microlens L2 may overlap the microlens L1, and a portion of the edge H3 of the microlens L3 may overlap one or both of the microlenses L1 and L2. For example, as for the microlens L2, a portion of the edge H2 along the side S12 may overlap the microlens L1. Similarly, as for the microlens L3, a portion of the edge H3 along the side S23 may overlap the microlens L2, and a portion of the edge H3 along the side S13 may overlap the microlens L1.

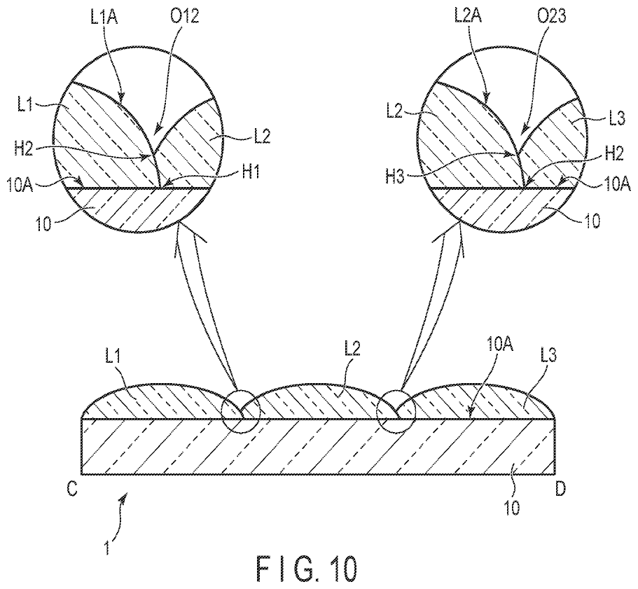

FIG. 10 is a cross-sectional view of the microlens array 1 taken along line C-D in FIG. 9. The example illustrated in FIG. 10 corresponds to a case where the edge H2 of the microlens L2 overlaps the microlens L1 and the edge H3 of the microlens L3 overlaps the microlens L2. That is, the microlens L2 of the example illustrated in FIG. 10 includes an overlapping portion O12 overlapping the microlens L1, and the microlens L3 includes an overlapping portion O23 overlapping the microlens L2. There are illustrated an enlarged view of the overlapping portion O12 on the left side in FIG. 10 and an enlarged view of the overlapping portion O23 on the right side in FIG. 10.

The microlenses L1 to L3 are disposed on the base layer 10. The edge H1 of the microlens L1 is in contact with an upper surface 10A of the base layer 10.

The edge H2 of the microlens L2 in the overlapping portion O12 on the left side in the figure is separated from the upper surface 10A and is in contact with a surface L1A of the microlens L1. The surface L1A between the edge H1 and the edge H2 can be recognized as a boundary between the microlens L1 and the microlens L2. Furthermore, the edge H2 of the microlens L2 under the overlapping portion O23 on the right side in the figure is in contact with the upper surface 10R.

The edge H3 of the microlens L3 in the overlapping portion O23 is separated from the upper surface 10A and is in contact with a surface L2A of the microlens L2. The surface L2A between the edge H2 and the edge H3 can be recognized as a boundary between the microlens L2 and the microlens L3.

Next, a second method for manufacturing the microlens array 1 according to the present embodiment will be described.

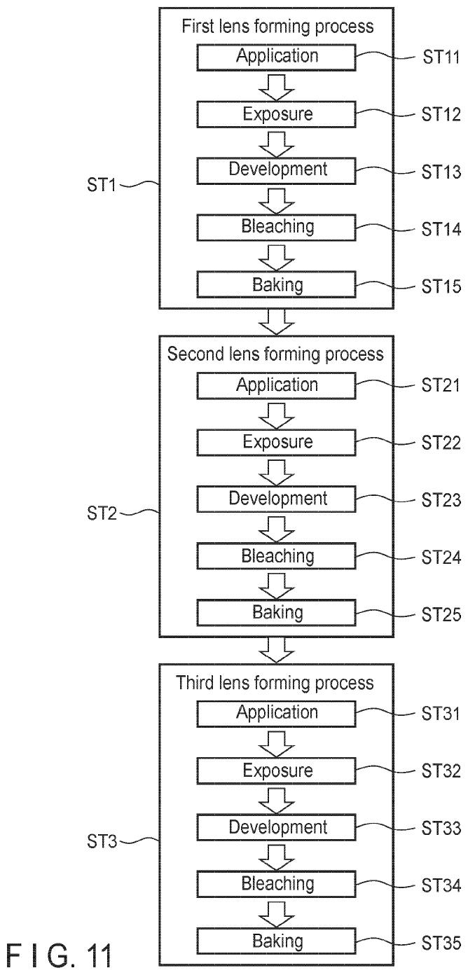

FIG. 11 is a flowchart for explaining the second method for manufacturing the microlens array 1.

First, a first lens forming process of forming the microlens L1 and the like illustrated in FIG. 9 is performed (step ST1). Subsequently, a second lens forming process of forming the microlens L2 and the like illustrated in FIG. 9 is performed (step ST2). Subsequently, a third lens forming process of forming the microlens L3 and the like illustrated in FIG. 9 is performed (step ST3).

The first lens forming process and the second lens forming process are as described with reference to FIG. 3. The third lens forming process includes an application process (step ST31), an exposure process (step ST32), a development process (step ST33), a bleaching process (step ST34), and a baking process (step ST35). Details of the processes are as described with reference to FIG. 3.

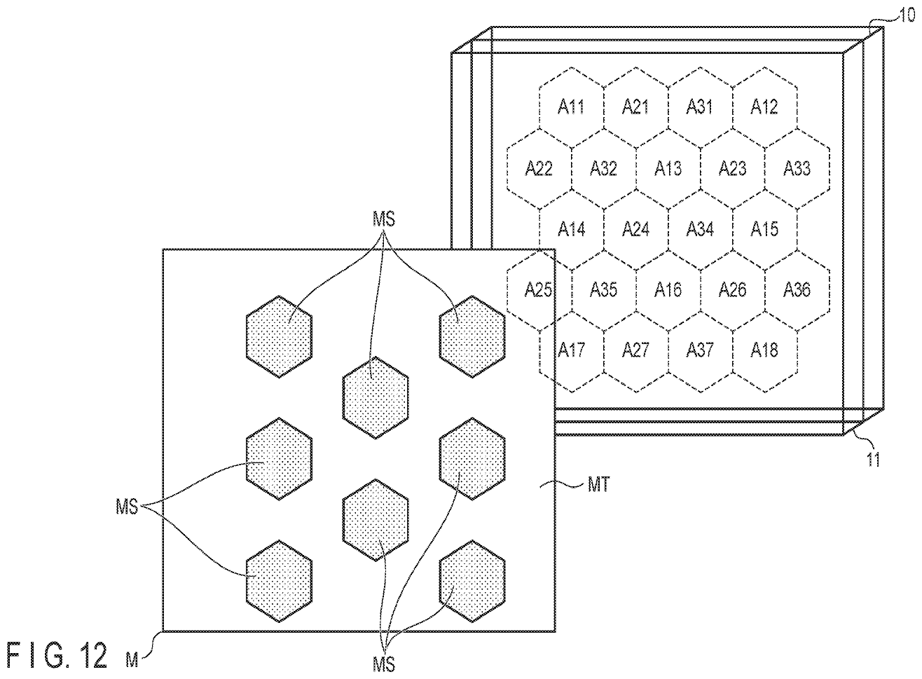

FIG. 12 is a view for explaining the first lens forming process ST1 for the third configuration example.

First, a photosensitive first resin layer 11 is formed over an area including areas A11 to A18, areas A21 to A27, and areas A31 to A37 on the base layer 10 (ST11).

Thereafter, a photomask M is aligned to form a state in which light shielding portions MS of the photomask M individually face the areas A11 to A18 and a light transmissive portion MT of the photomask M faces another area. The light shielding portions MS of the photomask M applicable herein have a hexagonal shape. The light shielding portions MS are arranged at intervals.

Subsequently, as illustrated in (B) of FIG. 4, the first resin layer 11 is exposed through the photomask M (ST12). Subsequently, as illustrated in (C) of FIG. 4, the first resin layer 11 is developed (ST13), and is then subjected to bleaching treatment (ST14). Subsequently, as illustrated in (D) of FIG. 4, the remaining first resin layer 11 is baked (ST15).

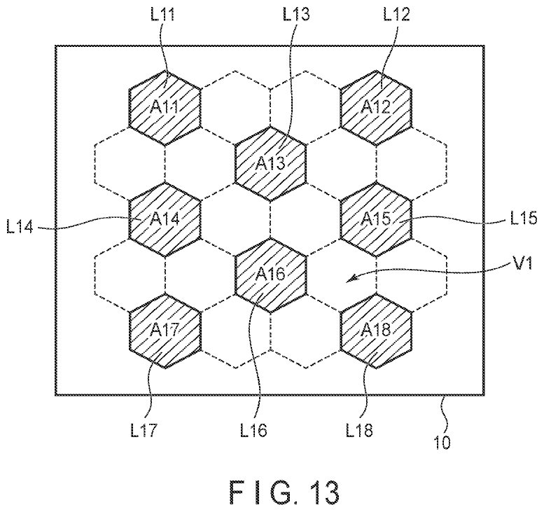

This results in, as illustrated in FIG. 13, formation of microlenses L11 to L18 in the areas A11 to A18, respectively. For example, the microlens L11 corresponds to the microlens L1 illustrated in FIG. 9. Furthermore, a vacant space (removed portion) V1 of the first resin layer 11 is formed around the microlenses L11 to L18.

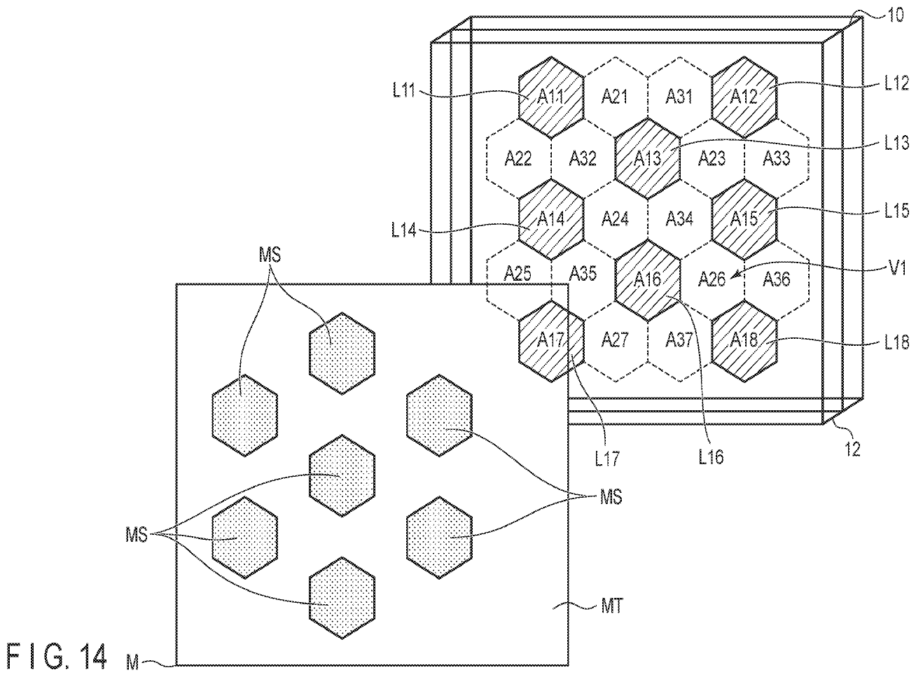

FIG. 14 is a view for explaining the second lens forming process ST2 for the third configuration example.

First, a photosensitive second resin layer 12 is formed over an area including the areas A21 to A27 on the base layer 10 (ST21). At this time, the second resin layer 12 is disposed over the microlenses L11 to L18 in the areas A11 to A18, and is disposed in the vacant space V1 in the areas A21 to A27 and the areas A31 to A37.

Thereafter, the photomask M is aligned to form a state in which the light shielding portions MS of the photomask M individually face the vacant space V1 in the areas A21 to A27 and the light transmissive portion MT of the photomask M faces another area including the microlenses L11 to L18.

Subsequently, as illustrated in (B) of FIG. 5, the second resin layer 12 is exposed through the photomask M (ST22). Subsequently, as illustrated in (C) of FIG. 5, the second resin layer 12 is developed (ST23), and is then subjected to the bleaching treatment (ST24). Subsequently, as illustrated in (D) of FIG. 5, the remaining second resin layer 12 is baked (ST25).

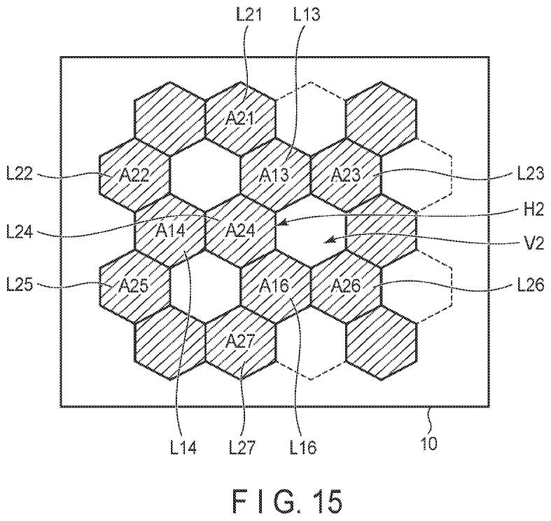

This results in, as illustrated in FIG. 15, formation of microlenses L21 to L27 in the areas A21 to A27, respectively. For example, the microlens L21 corresponds to the microlens L2 illustrated in FIG. 9. Furthermore, vacant spaces (removed portions) V2 of the second resin layer 12 are formed in areas adjacent to the microlenses L11 to L18 and the microlenses L21 to L27.

For example, in the example illustrated in FIG. 15, when focusing on the microlens L24 in the area A24, a portion of the hexagonal edge H2 may be separated from the base layer 10. In this case, the edge H2 may overlap each of the microlenses L13, L14, and L16.

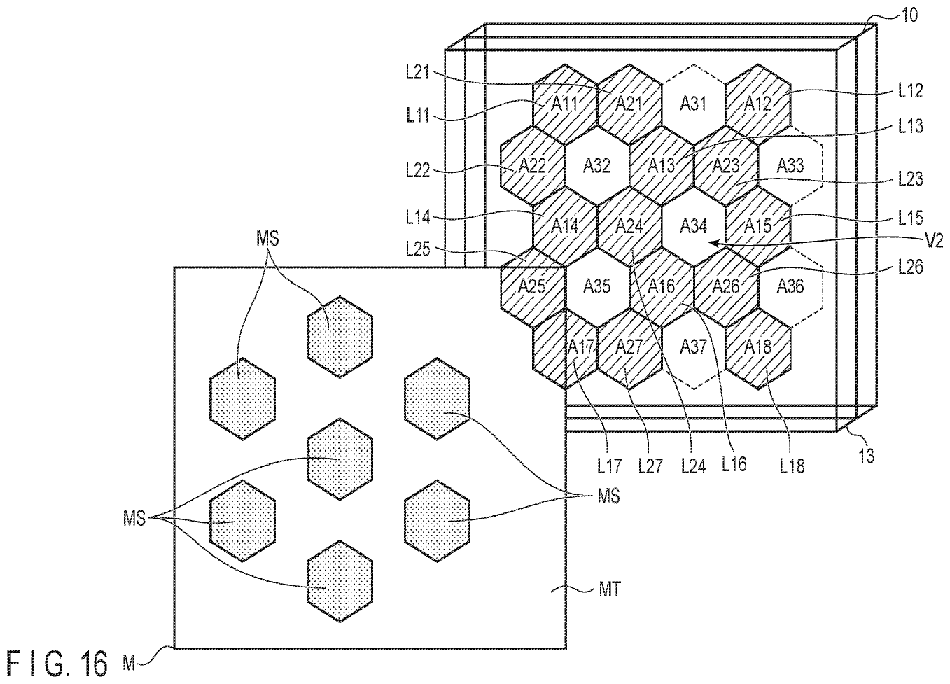

FIG. 16 is a view for explaining the third lens forming process ST3 for the third configuration example.

First, a photosensitive third resin layer 13 is formed over an area including the areas A31 to A37 on the base layer 10 (ST31). At this time, the third resin layer 13 is disposed over the microlenses L11 to L18 in the areas A11 to A18, is disposed over the microlenses L21 to L27 in the areas A21 to A27, and is disposed in the vacant spaces V2 in the areas A31 to A37.

Thereafter, the photomask M is aligned to form a state in which the light shielding portions MS of the photomask M individually face the vacant spaces V2 in the areas A31 to A37 and the light transmissive portion MT of the photomask M faces another area including the microlenses L11 to L18 and the microlenses L21 to L27.

Subsequently, the third resin layer 13 is exposed through the photomask M (ST32). Subsequently, the third resin layer 13 is developed (ST33). As a result, the third resin layer 13 disposed over the microlenses L11 to L18 and the microlenses L21 to L27 is removed. Thereafter, the third resin layer 13 remaining in the areas A31 to A37 is subjected to the bleaching treatment (ST34). Subsequently, the remaining third resin layer 13 is baked (ST35).

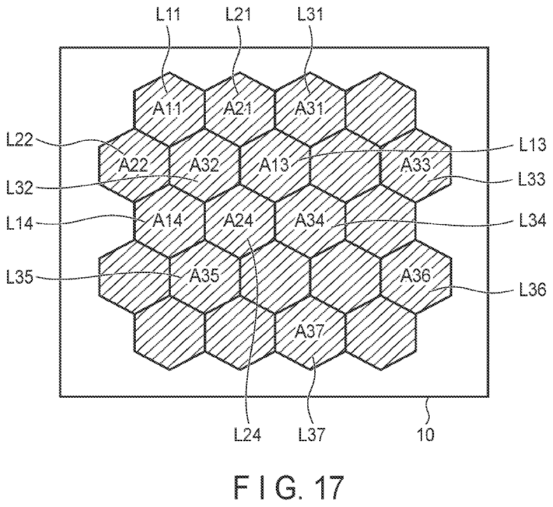

This results in, as illustrated in FIG. 17, formation of microlenses L31 to L37 in the areas A31 to A37, respectively. The microlens L32 corresponds to the microlens L3 illustrated in FIG. 9.

For example, in the example illustrated in FIG. 17, when focusing on the microlens L32 in the area A32, a whole of the hexagonal edge H3 may be separated from the base layer 10. In this case, a portion (first portion) of the edge H3 may overlap each of the microlenses L21, L22, and L24, and another portion (second portion) of the edge H3 may overlap each of the microlenses L11, L13, and L14.

Note that the light shielding portions MS and the light transmissive portion MT of the photomask M applied in the second lens forming process and the third lens forming process are the same in shape as those of the photomask M applied in the first lens forming process. Therefore, the common photomask M can be used in the first lens forming process, the second lens forming process, and the third lens forming process.

Also in such a third configuration example, similar effects to those in the first configuration example can be achieved.

In the above-described third configuration example, for example, the microlens L1 or the microlens L11 corresponds to a first microlens, the microlens L2 or the microlens L21 corresponds to a second microlens, the microlens L3 or the microlens L32 corresponds to a third microlens, the area A1 or the area A11 corresponds to a first area, the area A2 or the area A21 corresponds to a second area, and the area A3 or the area A32 corresponds to a third area.

In the microlens array 1 of the present embodiment, as described with reference to FIG. 2, it is possible to make the thickness between the adjacent microlenses (the thickness TO of the overlapping portion O12) substantially zero. As a result, a combination of a refractive index n10 of the base layer 10 and a refractive index nL of the microlens L allows for freely setting a focal length of the microlens L.

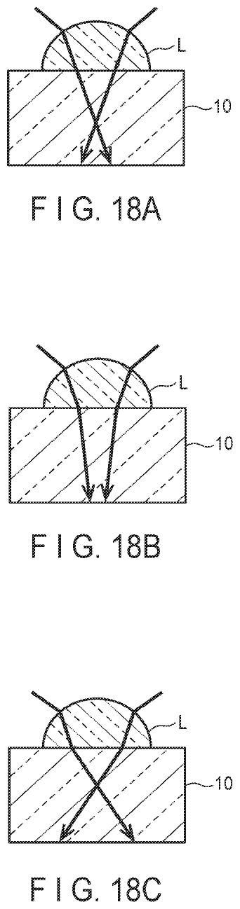

FIGS. 18A, 18B, and 18C are diagrams illustrating light beams passing through the microlens L and the base layer 10.

FIG. 18A illustrates light beams in a case where the refractive index nL is equivalent to the refractive index n10 (nL=n10). Light incident from the air onto the microlens L is refracted depending on a radius of curvature and the refractive index nL of the microlens L, and travels straight with little refraction at an interface between the microlens L and the base layer 10.

FIG. 18B illustrates light beams in a case where the refractive index nL is smaller than the refractive index n10 (nL<n10). Light incident from the air onto the microlens L is refracted depending on the radius of curvature and the refractive index nL of the microlens L, and is refracted depending on the refractive index n10 at the interface between the microlens L and the base layer 10. Such a combination of the refractive indexes allows for collimating the incident light or focusing the incident light with the focal length longer than the example illustrated in FIG. 18A.

FIG. 18C illustrates light beams in a case where the refractive index nL is greater than the refractive index n10 (nL>n10). Such a combination of the refractive indexes allows for focusing the incident light with the focal length shorter than the example illustrated in FIG. 18A.

As described above, according to the present embodiment, it is possible to improve the degree of freedom regarding an optical design of the microlens array 1.

Next, an application example of a microlens array 1 of the present embodiment will be described.

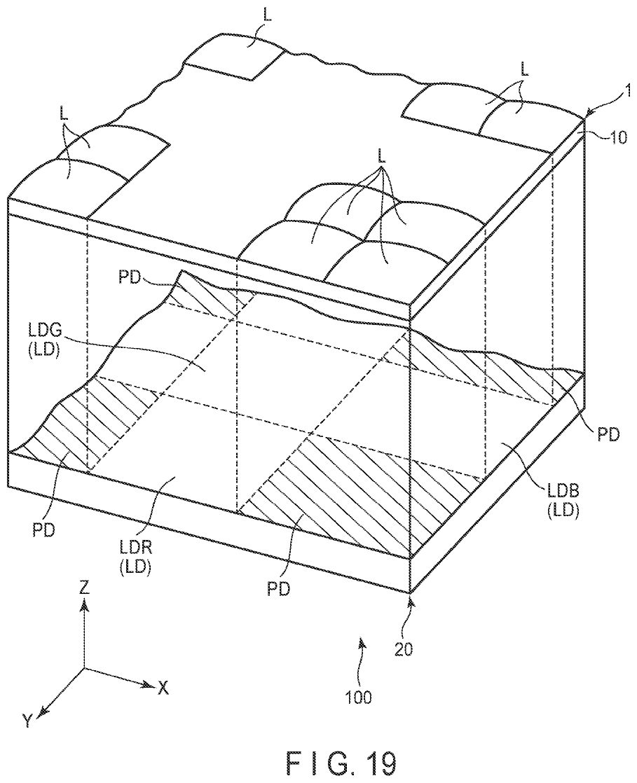

FIG. 19 is an exploded perspective view illustrating a configuration example of an electronic device 100. Note that, FIG. 19 illustrates a main portion of the electronic device 100 that is necessary for the description. The electronic device 100 includes a microlens array 1 and a sensor panel 20.

The sensor panel 20 includes, for example, a self-luminous light emitting element LD such as an organic electroluminescence (EL) element, a micro-LED, or a mini-LED. The light emitting element LD is configured to emit light toward the microlens array 1. The light emitting element LD includes, for example, a light emitting element LDR that emits red light, a light emitting element LDG that emits green light, and a light emitting element LDB that emits blue light.

In addition, the sensor panel 20 includes a photodetector PD. The light emitting element LDR, the light emitting element LDG, and the light emitting element LDB are disposed around the photodetector PD. The photodetectors PD are disposed in a matrix in the first direction X and the second direction Y. The photodetector PD is a photoelectric conversion element, and outputs an electric signal depending on received light. Note that a layout of the light emitting elements LD and the photodetectors PD illustrated herein is merely an example, and does not limit the present invention.

A base layer 10 of the microlens array 1 is disposed over the photodetectors PD, the light emitting element LDR, the light emitting element LDG, and the light emitting element LDB. A plurality of microlenses L adjacent to each other overlaps one of the photodetectors PD. In the example illustrated in FIG. 19, the four microlenses L overlap the one photodetector PD, but the number of the microlenses L overlapping the photodetector PD is not limit to four. Furthermore, no microlens L is disposed over the light emitting element LDR, the light emitting element LDG, and the light emitting element LDB.

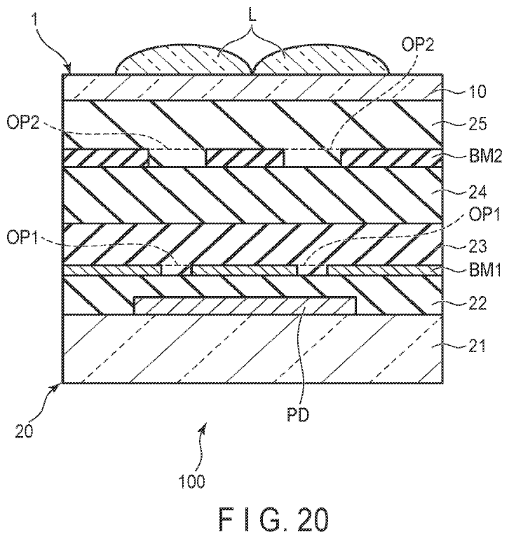

FIG. 20 is a cross-sectional view of the electronic device 100 including the photodetector PD in FIG. 19. The sensor panel 20 includes a substrate 21, an insulating layer 22, an infrared cut layer 23, an insulating layer 24, an insulating layer 25, the photodetector PD, a light shielding layer BM1, and a light shielding layer BM2.

The substrate 21 is, for example, an insulating substrate such as a glass substrate or a resin substrate. The photodetector PD is disposed on the substrate 21 and is covered with the transparent insulating layer 22. The light shielding layer BM1 is disposed on the insulating layer 22 and is covered with the infrared cut layer 23. The light shielding layer BM1 is formed of, for example, a light shielding metal material, and has an opening (pinhole) OP1 immediately above the photodetector PD.

The infrared cut layer 23 is formed of a material that absorbs long-wavelength light such as red light and infrared light, which can be noise light for the photodetector PD. The infrared cut layer 23 is covered with the transparent insulating layer 24. The light shielding layer BM2 is disposed on the insulating layer 24 and is covered with the transparent insulating layer 25. The light shielding layer BM2 is formed of, for example, a light shielding organic material, and has an opening (pinhole) OP2 immediately above the opening OP1. In an example, the opening OP2 has a diameter greater than a diameter of the opening OP1. The insulating layer 24 and the insulating layer 25 are formed of, for example, an organic material.

The microlens array 1 is disposed on the insulating layer 25. In a case where the microlens array 1 is formed separately from the sensor panel 20, the base layer 10 is adhered to the insulating layer 25. Alternatively, the microlens array 1 may be formed integrally with the sensor panel 20, and in this case, the insulating layer 25 may be substituted for the base layer 10.

The lens L is disposed immediately above the opening OP2. The opening OP1 and the opening OP2 are located on an optical axis of the lens L.

In the electronic device 100 having such a configuration, light emitted from the light emitting element LD is reflected by an object above the lens L. This reflected light is, for example, collimated by the lens L, passes through the opening OP2 and the opening OP1, and is detected by the photodetector PD.

As described above, according to the present embodiment, it is possible to provide a microlens array of which density can be increased and a method for manufacturing the same.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for manufacturing a microlens array comprising:
forming a first resin layer that is photosensitive on a base layer;
exposing the first resin layer through a photomask including a light shielding portion and a light transmissive portion;
developing the first resin layer to form a vacant space of the first resin layer;
melting the first resin layer that is remaining to form a first microlens;
forming a second resin layer that is photosensitive over the first microlens and the vacant space;
exposing the second resin layer in a state where a light shielding portion of a photomask faces the vacant space and a light transmissive portion of the photomask faces the first microlens;
developing the second resin layer to remove the second resin layer on the first microlens; and
melting the second resin layer that is remaining to form a second microlens in contact with the first microlens.

2. The method for manufacturing a microlens array according to claim 1, wherein the light shielding portion has a quadrangular shape or a circular shape.

3. The method for manufacturing a microlens array according to claim 2, wherein a portion of an edge of the second microlens is in contact with a surface of the first microlens.

4. The method for manufacturing a microlens array according to claim 1, wherein the photomask applied in the exposing the first resin layer is same as the photomask applied in the exposing the second resin layer.

5. The method for manufacturing a microlens array according to claim 1, further comprising:
forming a third resin layer that is photosensitive over a vacant space formed by the developing the second resin layer, the first microlens, and the second microlens;
exposing the third resin layer in a state where a light shielding portion of a photomask faces the vacant space and a light transmissive portion of the photomask faces the first microlens and the second microlens;
developing the third resin layer to remove the third resin layer on the first microlens and the second microlens; and
melting the third resin layer that is remaining to form a third microlens in contact with the first microlens and the second microlens.

6. The method for manufacturing a microlens array according to claim 5, wherein the light shielding portion has a hexagonal shape.

7. The method for manufacturing a microlens array according to claim 6, wherein
a portion of an edge of the second microlens is in contact with a surface of the first microlens,
a first portion of an edge of the third microlens is in contact with a surface of the second microlens, and
a second portion of the edge of the third microlens is in contact with the surface of the first microlens.

8. The method for manufacturing a microlens array according to claim 5, wherein at least two of the photomask applied in the exposing the first resin layer, the photomask applied in the exposing the second resin layer, and the photomask applied in the exposing the third resin layer are same.

9. A method for manufacturing a microlens array comprising:
forming a first resin layer that is photosensitive over a first area and a second area adjacent to each other on a base layer;
exposing the first resin layer in a state where a light shielding portion of a photomask faces the first area and a light transmissive portion of the photomask faces the second area;
developing the first resin layer to remove the first resin layer in the second area;
melting the first resin layer that is remaining in the first area to form a first microlens;
forming a second resin layer that is photosensitive over the first microlens and the second area;
exposing the second resin layer in a state where a light shielding portion of a photomask faces the second area and a light transmissive portion of the photomask faces the first microlens;
developing the second resin layer to remove the second resin layer on the first microlens; and
melting the second resin layer that is remaining in the second area to form a second microlens in contact with the first microlens.

10. The method for manufacturing a microlens array according to claim 9, wherein the photomask applied in the exposing the first resin layer is same as the photomask applied in the exposing the second resin layer.

11. The method for manufacturing a microlens array according to claim 9, further comprising:
forming a third resin layer that is photosensitive over the first microlens, the second microlens, and a third area adjacent to the first area and the second area;
exposing the third resin layer in a state where a light shielding portion of a photomask faces the third area and a light transmissive portion of the photomask faces the first microlens and the second microlens;
developing the third resin layer to remove the third resin layer on the first microlens and the second microlens; and
melting the third resin layer that is remaining in the third area to form a third microlens in contact with the first microlens and the second microlens.

12. The method for manufacturing a microlens array according to claim 11, wherein at least two of the photomask applied in the exposing the first resin layer, the photomask applied in the exposing the second resin layer, and the photomask applied in the exposing the third resin layer are same.

13. A microlens array comprising:
a base layer; and
a first microlens and a second microlens that are disposed on the base layer and are in contact with each other, wherein
a whole of an edge of the first microlens is in contact with the base layer, and
a portion of an edge of the second microlens is in contact with a surface of the first microlens.

14. The microlens array according to claim 13, wherein
the second microlens includes an overlapping portion overlapping the first microlens and a lens portion prominent from the overlapping portion, and
the lens portion is thicker than the overlapping portion.

15. The microlens array according to claim 13, wherein the first microlens and the second microlens each have a quadrangular shape, a circular shape, or a hexagonal shape in plan view.

16. The microlens array according to claim 13, wherein the first microlens and the second microlens each have a refractive index different from a refractive index of the base layer.
